(19) United States
(12) Patent Application Publication
(10) Pub. No.: US 2023/0392438 A1
(43) Pub. Date: Dec. 7, 2023

(54) SYSTEM AND METHOD FOR IMPLEMENTING AN IMPROVED BI-FOLD SHUTTER

(71) Applicant: OLSON KUNDIG, INC., Seattle, WA (US)

(72) Inventors: Phillip Turner, Mukilteo, WA (US); Tom Kundig, Seattle, WA (US); Jeremy Kramp, Gig Harbor, WA (US); Steven Rainville, Seattle, WA (US)

(21) Appl. No.: 18/231,596

(22) Filed: Aug. 8, 2023

Related U.S. Application Data
(63) Continuation of application No. 17/719,223, filed on Apr. 12, 2022, now abandoned.

(51) Int. Cl. E06B 9/06; E06B 3/48; E05D 1/00; E05D 15/26

(52) U.S. Cl. CPC E06B 9/0638; E06B 9/0669; E06B 3/483; E05D 1/00; E05D 15/264; E06B 2009/005

(57) ABSTRACT

An improved bi-fold shutter that includes a more efficient coupling mechanism at a hinge point suited to facilitate opening and closing the bi-fold shutter with greater ease. In one embodiment, the shutter may be designed for a window such that the shutter, when closed, is relatively close to the face of the associated window, and when open, forms an awning or overhang. The shutter includes an improved coupling mechanism at a hinge point between a first shutter portion and a second shutter portion. The improved hinge point shifts a direction of force needed to maneuver the shutter when moving the shutter from one position to another. The shift in opening and closing force directions improves the efficiency by which the shutter can be operated. In some embodiments, the shutter may be hand-operated. In other embodiments, the shutter may be powered.

### PRIORITY CLAIM

This application claims the benefit of U.S. Provisional Application No. 62/311,718, entitled “System and Method for An Improved Bi-Fold Shutter,” filed Mar. 22, 2016, which is incorporated by reference in its entirety herein for all purposes.

### BACKGROUND

Architects and engineers have developed various windows, door, and window coverings in buildings for hundreds of years. Design of a window itself will usually include a way to open the window and then subsequently close the window. Similar aspects are also involved with doors and window coverings. A particular subset of window coverings is called window shutters. Window shutters may be designed to block, tune, or modulate light from coming through a window or may be designed to protect a window from severe weather. Common designs for shutters have also been around for hundreds of years.

In more modem designs, the manner in which the window shutter opens and closes may provide additional architectural or engineering features. For example, the window shutter itself may provide shade when opened or look aesthetically pleasing when in the open or closed position. However, various conventional designs of window shutters are typically clunky and somewhat difficult to operate even with motorized assistance.

### BRIEF DESCRIPTION OF THE DRAWINGS

Aspects and many of the attendant advantages of the claims will become more readily appreciated as the same become better understood by reference to the following detailed description, when taken in conjunction with the accompanying drawings, wherein:

FIG. 1 is a diagram of a bi-fold window shutter showing an inefficient design for the mechanism to open and close the window shutter.

FIG. 2 is a diagram of an improved bi-fold window shutter showing a more efficient design for the mechanism to open and close the window shutter according to an embodiment of the subject matter disclosed herein.

FIG. 3 is a diagram of an improved hinge mechanism for the bi-fold window shutter of FIG. 2 in a retracted position according to an embodiment of the subject matter disclosed herein.

FIG. 4 is a diagram of an improved hinge mechanism for the bi-fold window shutter of FIG. 2 in an extended position according to an embodiment of the subject matter disclosed herein.

FIG. 5 is a diagram of another improved hinge mechanism for the bi-fold window shutter of FIG. 2 in a retracted position according to an embodiment of the subject matter disclosed herein.

FIG. 6 is a diagram of another improved hinge mechanism for the bi-fold window shutter of FIG. 2 in an extended position according to an embodiment of the subject matter disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

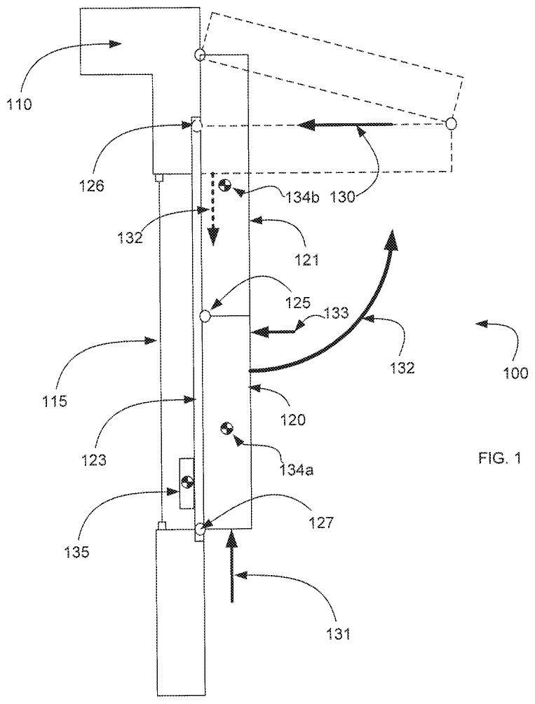

By way of overview, the subject matter disclosed herein may be an improved bi-fold shutter that includes a more efficient coupling mechanism at a hinge point suited to facilitate opening and closing the bi-fold shutter with greater ease. In one embodiment, the shutter may be designed for a window such that the shutter, when closed, is relatively close to the face of the associated window, and when open, forms an awning or overhang. The shutter includes an improved coupling mechanism at a hinge point between a first shutter portion and a second shutter portion. The improved hinge point shifts a direction of force needed to maneuver the shutter when moving the shutter from one position to another. The shift in opening and closing force directions improves the efficiency by which the shutter can be operated. In some embodiments, the shutter may be hand-operated. In other embodiments, the shutter may be powered. These and other aspects and features are discussed below with respect to FIGS. 1-6.

FIG. 1 is a diagram of a bi-fold window shutter 100 showing an inefficient design for the mechanism to open and close the window shutter. In FIG. 1, a side view of the shutter 100 is shown in two positions relative to a window 115 of a building 110. The first position is a retracted or closed position and is shown with solid lines. The second position is an extended or open position and is shown with broken lines. The window shutter 100 of FIG. 1 is shown situated on an outer facing of the building 110 on or next to the window opening 115. Further, the window shutter 100 may include two portions. In FIG. 1, the portions include a first lower portion 120 and a second upper portion 121. The two portions may be attached to each other at a coupling point by a conventional pivoting hinge 125.

When a person wished to extend (e.g., open) the window shitter 100, a force 131 is applied in an upward direction to the lower portion 120, the two portions may swing out away from the window 115 at the coupling point hinge 125 Because the upper portion 121 is attached to the building at a stationary pivoting hinge 126, the two portions fold together into the open position shown in broken lines. This is further assisted by a guide track 123 that keeps a pin assembly 127 of the lower portion 120 in a plane parallel to the window 115.

When a person wants to retract the shutters, a force 132 may be applied in the downward direction on the lower portion 120. However, because of the pin assembly 127 and the coupling point with the pivoting hinge 125 are aligned in the same horizontal plane, there is no downward thrust force applied to the shutter itself. Rather, the thrust is only in the horizontal plane as shown by force 130. That is the downward force 132 is orthogonal to the force 130 needed to overcome any holding force of the window shutter 100 in the open position. This makes closing the shutter difficult and inefficient.

Furthermore, in the design of the window shutter 110 in FIG. 1, the locations of the coupling point hinge 125 and the stationary pivoting hinge 126, prevent the shutter from resting in a fully closed position. This is because the combined centers of gravity 134a/b of the first portion 120 and the second portion 121 tend to cause the window shutter 100 to rest is a slightly askew and open position. If a force 133 is applied to the shutters to remain closed, the shutter portions 120 and 121 may bind in place and be difficult to wrest open again.

Further disadvantages of the window shutter 100 of FIG. 1 are numerous. Various part of the overall assembly protrude into the building interior as one or more additional counterweights 135 are needed. As the window shutter 100 tends to lock into place at the open position, additional devices (not shown) are needed to initiate the closing maneuver. Even further devices (also not shown) may be needed to apply enough force to fully close the window shutter 100. The lower portion of the window shutter 100 typically cannot be raised to a fully horizontal position which is displeasing to the discerning eye. Unsightly and bulky operating mechanisms haunt the designer's vision when the window shutter 100 of FIG. 1 is deployed. Complex hydraulic systems and electrical operators cause additional inefficiencies and maintenance and also require power for both opening and closing maneuvers. Additional drawbacks exist but are not enumerated for the sake of brevity.

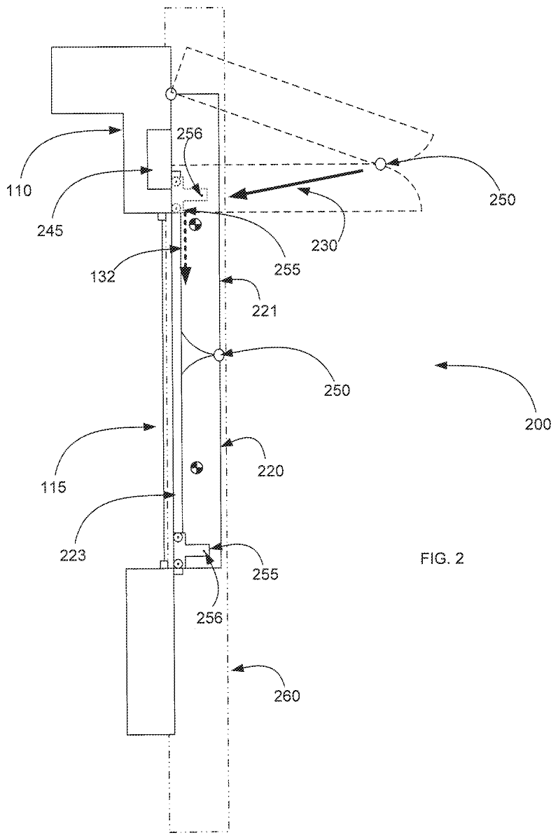

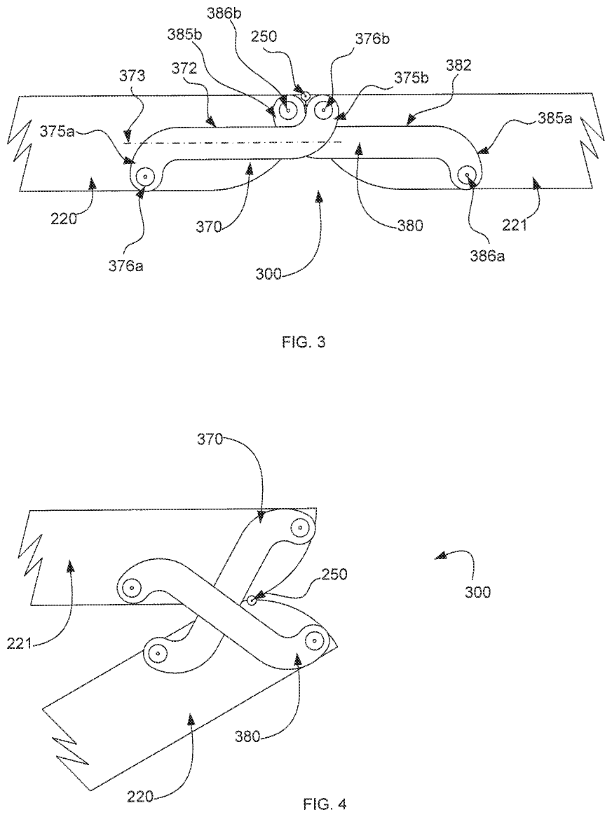

FIG. 2 is a diagram of an improved bi-fold window shutter 200 showing a more efficient design for the mechanism to open and close the window shutter 200 according to an embodiment of the subject matter disclosed herein. The window shutter 200 in this embodiment includes a first lower portion 220 (e.g., a first rigid member) and a second upper portion 221 (e.g., a second rigid member) that are coupled together at a coupling utilizing a variable center hinge (shown in greater detail in FIGS. 3-6 below). The variable center hinge provides for a coupling point 250 between an upper end of the lower portion 221 and a lower end of the upper portion 220 of the window shutter 200, such that the coupling point 250 may move relative to the two portions of the window shutter 200 when in motion. As is shown in FIGS. 3-6, the center of rotation (e.g., the moving pivot point 250) of the variable center hinge shifts during maneuvering from near the outer face of the frame (as is shown in the closed shutter position) to near the inner face of the frame (as is shown in the open shutter position). That is, the coupling point 250 is between the first end of the first rigid member and the first end of the second rigid member wherein the coupling point 250 includes a rotation point that moves relative to the first end of the first rigid member 221 and relative to the first end of the second rigid member 220.

In this manner, the non-coupling ends of the window shutter 200 (e.g., the second end (the lower end) of the first rigid member 221 and the second end (the upper end) of the second rigid member 220 are fix within a vertical plane of motion 260 that is parallel with the window 115 and the guide track 223. This plane 260 is disposed such that the second end of the first rigid member 220 and the second end of the second rigid member 221 remain in the plane 260 during window shutter 200 motion and disposed such that the coupling 250 deviates from the plane 260 during window shutter 200 motion.

The window shutter 200 is supplemented with a lower roller assembly 255 that assists with overcoming the coefficient of friction when maneuvering the window shutter 200 from position to position. The roller assembly 225 includes wheels that remain in a plane of motion 260 parallel to the window 115. In an embodiment, the wheels are encompassed in the guide track 223. As the window shutter 200 moves to the open position, the window shutter 200 rotates about a pivot point 256 at the lower end (e.g., a second end opposite the first end at the upper end) of the lower portion 220.

The variable center hinge and the roller assembly 225 assist with reducing the force needed to maneuver the window shutter 200—especially when is a fully open or fully closed position. One reason for the reduction in force is that the thrust force 230 needed to move the shutter 200 out of the fully open position is now angled with respect to a normal of the plane of motion 260. This is because the rotation point 250 moves relative to the windows shutter portions 220 and 221. Thus, when in the fully open position, the thrust force 230 is angled from the center of rotation point 250 to the roller assembly 225 pivot point 256 so that at least some of the downward force 132 used to attempt to close the window shutter 200 is translated to this force angle 230. In some embodiments, the window assembly may include a motor 245 configured to actuate the window shutter from an extended position to a retracted position and configured to actuate the window shutter from the retracted position to the extended position.

The embodiments of the coupling are discussed next with respect to FIGS. 3-6 and provide a better understanding of the rotation point being relative to the motion of the window shutter members 220 and 221.

FIG. 3 is a diagram of an improved hinge mechanism 300 for the bi-fold window shutter of FIG. 2 in a closed position according to an embodiment of the subject matter disclosed herein. The improved hinge mechanism 300 (sometimes called a variable center hinge) provides the coupling between portions 220 and 221 of the window shutter of FIG. 2 and includes a first member 370 and a second member 380. Each member 370 and 380 includes an elongated center portion 372 and 382 that each culminate in two protruding ends 375a/b and 385a/b. With respect to the first member 370, the protruding ends 375a/b may protrude away from the elongated center portion 372 in opposite angled directions with respect to a center line 373 of the elongated center portion 372. With respect to the second member 380, the protruding ends 385a/b may protrude away from the elongated center portion 382 in similar opposite angled directions with respect to a center line (not shown) of the elongated center portion 382.

In this embodiment, one protruding end 375a of the first member 370 is pivotally attached (at pivot point 376a) to an end of the lower section 220 of the window shutter 200 and the other protruding end 375b of the first member 370 is pivotally attached (at pivot point 376b) to an end of the upper portion 221 of the window shutter 200. In an opposite manner (mirror-image in the retracted position), one protruding end 385a of the second member 380 is pivotally attached (at pivot point 386a) to an end of the lower section 220 of the window shutter 200 and the other protruding end 375b of the second member 380 is pivotally attached (at pivot point 386b) to an end of the upper portion 221 of the window shutter 200. Further, the two members 370 and 380 may be nested such that one protruding end 375b of a first member 370 nests around (e.g., on the outside of) a protruding end 385b of the second member 380 as shown.

In this manner, when in the closed position (e.g., retracted), the relative coupling point 250 is aligned with the outer edge (top edge with respect to the alignment of the window shutter as depicted in FIG. 3). However, as the window shutter 200 begins to move into an open position, the coupling point 250 will move along a range of motion at the ends of the portions 220 and 221 of the window shutter 200 in manner relative to the motion of the ends of the window shutter members 220 and 221. This can be seen in FIG. 4 when the window shutter 200 is maneuvered to an open position (e.g., extended).

FIG. 4 is a diagram of the improved hinge mechanism 300 of FIG. 3 for the bi-fold window shutter 200 of FIG. 2 in an open position according to an embodiment of the subject matter disclosed herein. As the improved hinge mechanism 300 is maneuvered, the protruding ends 375a/b and 385a/b of each member 370 and 380 pivot about the attached pivoting points 376a/b and 386a/b at each end of each shutter portion 220 and 221. FIG. 4 shows the variable center hinge 300 in an open shutter position so that one can see that the relative rotation point 250 has now moved along the coupling to be located away from the outer edge of the window shutter 200.

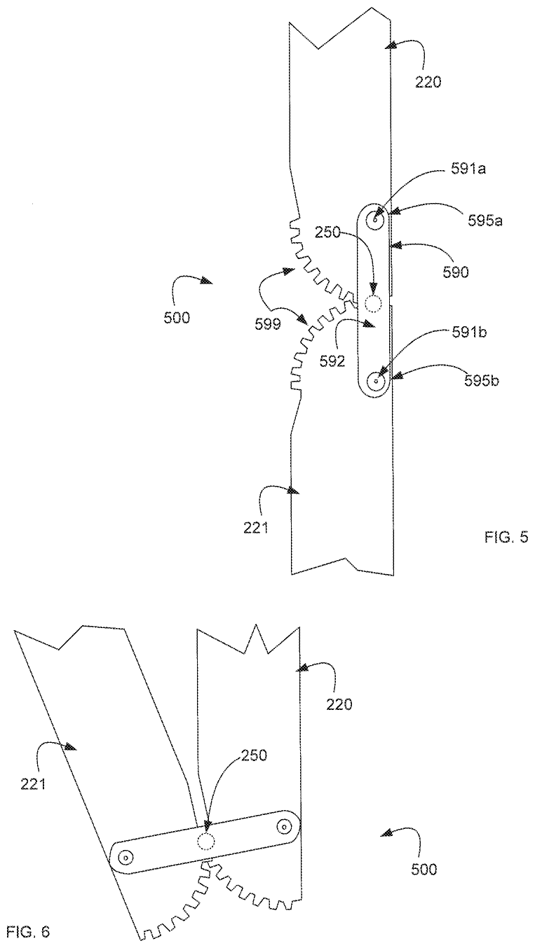

FIG. 5 is a diagram of another improved hinge mechanism 500 for the bi-fold window shutter of FIG. 2 in a retracted position according to an embodiment of the subject matter disclosed herein. The improved hinge mechanism 500 provides the coupling between portions 220 and 221 of the window shutter of FIG. 2 and includes a member 590 that is coupled at respective pivot points 591a/b on each respective portion 220 and 221. The member 590 includes an elongated center portion 592 that each culminate in two ends 595a/b.

In this embodiment, one end 595a of the member 590 is pivotally attached (at pivot point 591a) to an end of the lower section 220 of the window shutter 200 and the other end 595b of the member 390 is pivotally attached (at pivot point 591b) to an end of the upper portion 221 of the window shutter 200. In this manner, when in the closed position (e.g., retracted), the relative coupling point 250 is aligned with the outer edge. However, as the window shutter 200 begins to move into an open position, the coupling point 250 will move along a range of motion at the ends of the portions 220 and 221 of the window shutter 200 in manner relative to the motion of the ends of the window shutter members 220 and 221. This can be seen in FIG. 6 when the window shutter 200 is maneuvered to an open position (e.g., extended).

The embodiment of FIG. 5 may include additional inter-weaving teeth 599 that may assist with facilitating the move from open to closed position or from the closed to open position. Various embodiment may also have a different shape of hinged member 590 for facilitating the pivoting and the coupling.

FIG. 6 is a diagram of another improved hinge mechanism 500 for the bi-fold window shutter 200 of FIG. 2 in an extended position according to an embodiment of the subject matter disclosed herein. As the improved hinge mechanism 500 is maneuvered, the ends 595a/b of the member 590 pivot about the attached pivot points 591a/b at each end of each shutter portion 220 and 221. FIG. 6 shows the variable center hinge 500 in an open shutter position so that one can see that the relative rotation point 250 has now moved along the coupling to be located away from the outer edge of the window shutter 200.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. A window shutter, comprising:
a first member having a first end and a second end;
a second member having a first end and a second end; and
a coupling between the first end of the first member and the first end of the second member wherein the coupling includes a rotation point that moves relative to the first end of the first member and relative to the first end of the second member.

2. The window shutter of claim 1, further comprising a plane of motion disposed such that the second end of the first member and the second end of the second member remain in the plane of motion during window shutter motion and disposed such that the coupling deviates from the plane of motion during window shutter motion.

3. The window shutter of claim 1, wherein coupling further comprises a variable center hinge including a first hinge member having and elongated center portion flanked by two angled protruding ends and a second hinge member having and elongated center portion flanked by two angled protruding ends.

4. The window shutter of claim 3, wherein:
a first angled protruding end of the first hinge member is pivotally coupled to the first end of the first member;
a second angled protruding end of the first hinge member is pivotally coupled to the first end of the second member;
a first angled protruding end of the second hinge member is pivotally coupled to the first end of the second member; and
a second angled protruding end of the second hinge member is pivotally coupled to the first end of the first member.

5. The window shutter of claim 1, wherein coupling further comprises a hinge member having an elongated center portion flanked by two ends wherein a first hinge member end is pivotally coupled to a first end of the first member and a second hinge member end is pivotally coupled to a first end of the second member.

6. The window shutter of claim 1, wherein second end of first member is coupled to a stationary pivot point so that the second end remains fixed about the stationary pivot point during motion.

7. The window shutter of claim 1, wherein the second end of the second member comprises a roller assembly pivotally attached to the second end of the second member.

8. The window shutter of claim 1, wherein the first end of the first member and the first end of the second member comprise curved contours.

9. The window shutter of claim 1, wherein the first end of the first member and the first end of the second member comprise interweaving teeth.

10. The window shutter of claim 1, wherein the first end of the first member and the first end of the second member comprise a rigid wood material.

11. A window assembly, comprising:
a window frame;
a window fixed in the window frame;
a window shutter coupled to the window frame, the window shutter including:
a first member having a first end and a second end;
a second member having a first end and a second end; and
a coupling between the first end of the first member and the first end of the second member wherein the coupling includes a rotation point that moves relative to the first end of the first member and relative to the first end of the second member.

12. The window assembly of claim 11, further comprising a plane of motion parallel to the window disposed such that the second end of the first member and the second end of the second member remain in the plane of motion during window shutter motion and disposed such that the coupling deviates from the plane of motion during window shutter motion.

13. The window assembly of claim 11, further comprising a motor configured to actuate the window shutter from an extended position to a retracted position and configured to actuate the window shutter from the retracted position to the extended position.

14. The window assembly of claim 11, wherein coupling further comprises a variable center hinge including a first hinge member having and elongated center portion flanked by two angled protruding ends and a second hinge member having and elongated center portion flanked by two angled protruding ends.

15. The window assembly of claim 14, wherein:
a first angled protruding end of the first hinge member is pivotally coupled to the first end of the first member;
a second angled protruding end of the first hinge member is pivotally coupled to the first end of the second member;
a first angled protruding end of the second hinge member is pivotally coupled to the first end of the second member; and
a second angled protruding end of the second hinge member is pivotally coupled to the first end of the first member.

16. The window assembly of claim 11, wherein coupling further comprises a hinge member having an elongated center portion flanked by two ends wherein a first hinge member end is pivotally coupled to a first end of the first member and a second hinge member end is pivotally coupled to a first end of the second member.

17. The window assembly of claim 11, wherein the second end of the second member comprises a roller assembly pivotally attached to the second end of the second member and translationally coupled to a guide track affixed to the window frame.

18. The window assembly of claim 11, wherein the first end of the first member and the first end of the second member comprise curved contours.

19. The window assembly of claim 11, wherein the first end of the first member and the first end of the second member comprise interweaving teeth.

20. The window assembly of claim 11, wherein the first end of the first member and the first end of the second member comprise a rigid wood material.
